(19) United States
(12) Patent Application Publication
(10) Pub. No.: US 2011/0163533 A1
(43) Pub. Date: Jul. 7, 2011

(54) SYSTEM, METHOD AND APPARATUS FOR TUBING CONNECTOR

(75) Inventors: Mitchell L. Snyder, Midland, MI (US); Rod J. Leslie, Clare, MI (US); Clemens E. Zoellner, Bay City, MI (US); Jean Schook, Gladwin, MI (US); Anthony M. Diodati, Mullica Hill, NJ (US)

(73) Assignee: SAINT-GOBAIN PERFORMANCE PLASTICS CORPORATION, Aurora, OH (US)

(21) Appl. No.: 12/980,795

(22) Filed: Dec. 29, 2010

Related U.S. Application Data
(60) Provisional application No. 61/291,702, filed on Dec. 31, 2009.

(51) Int. Cl. F16L 55/00

(52) U.S. Cl. 285/88

(57) ABSTRACT

A retainer clenches on tubing to secure a fitting and form a compression seal and connection therebetween. The retainer has first and second portions joined by a hinge and is movable from an open position to a closed position. The closed position defines an aperture in which the tubing and fitting are clenched. The retainer has a small aspect ratio with respect to the diameter and axial width of the retainer. A rib circumscribes and extends radially into the aperture to place a pre-load on the tubing to intensify a compression force of the retainer.

This application claims priority to and the benefit of U.S. Provisional App. No. 61/291,702, filed Dec. 31, 2009, and is incorporated herein by reference in its entirety.

### FIELD OF THE DISCLOSURE

The invention relates in general to retainers and, in particular, to an improved system, method and apparatus for a tubing connector that creates compression between tubing and a hose-barbed fitting.

### BACKGROUND

The connection of thermoplastic-elastomer (TPE) or silicone tubing is typically accomplished with a fitting that is inserted into the tubing and is secured with an external plastic clamp or retainer. The fittings usually comprise barbed connectors, and the retainers comprise zip ties, worm gear clamps, Kwik Clamps™, BarbLock® connectors and the like. Zip ties are inexpensive but form unreliable seals for some applications, and the other types of connectors are more expensive.

In pharmaceutical and medical applications, such tubing connections are often subjected to autoclave environments at elevated temperatures and pressures. Autoclaves can significantly alter the properties of the materials used to form the tubing, connectors and clamps, and thus reduce the efficacy of or even destroy the seal formed at the retainer over the hose-barbed fitting. For example, conventional thermoplastics are limited to a maximum autoclave temperature of 132° C. with an exposure time of only 10 minutes. Moreover, conventional designs should not be secured with a retainer or placed under load during sterilization to avoid permanent deformation. Although known tubing connections are workable for some applications, an improved design that is more reliable, affordable and capable of higher performance in autoclave applications would be desirable.

### SUMMARY OF THE INVENTION

Embodiments of a system, method and apparatus for a tubing connector that creates compression between tubing and fittings are disclosed. In some embodiments, the connector and tubing system comprise a retainer that clenches on the tubing adjacent the end around a fitting to form a compression seal and connection therebetween. The retainer comprises a body having first and second portions joined by a hinge and movable from an unlocked open position to a locked closed position. The locked closed position defines an aperture that is cylindrical with a diameter in which the tubing and fitting are clenched.

In some embodiments, the retainer has an aspect ratio of approximately 1:1 with respect to the diameter and axial width of the retainer. In other embodiments, the aspect ratio is about 0.7:1 to 1.3:1. A rib may be formed in and substantially circumscribe the aperture. The rib extends radially into the aperture to reduce a diameter of at least a portion of the aperture. The rib places a pre-load on the tubing to intensify a compression force of the retainer over the hose-barbed fitting and tubing.

### BRIEF DESCRIPTION OF THE DRAWINGS

The present disclosure may be better understood, and its numerous features and advantages made apparent to those skilled in the art by referencing the accompanying drawings.

FIG. 1 is an end view of one embodiment of a retainer and is shown open prior to clenching on a tube;

FIG. 2 is an end view of the retainer of FIG. 1 shown clenched on the tube;

FIG. 3 is a sectional side view of the retainer of FIG. 2 shown clenched on the tube;

FIG. 4 is an end view of an alternate embodiment of a retainer and is shown open prior to clenching on a tube;

FIG. 5 is an end view of the retainer of FIG. 4 shown clenched on the tube;

FIG. 6 is a sectional side view of the retainer of FIG. 5 shown clenched on the tube and fitting; and

FIGS. 7, 8 and 9 are isometric and end views of another embodiment of a retainer.

The use of the same reference symbols in different drawings indicates similar or identical items.

### DETAILED DESCRIPTION

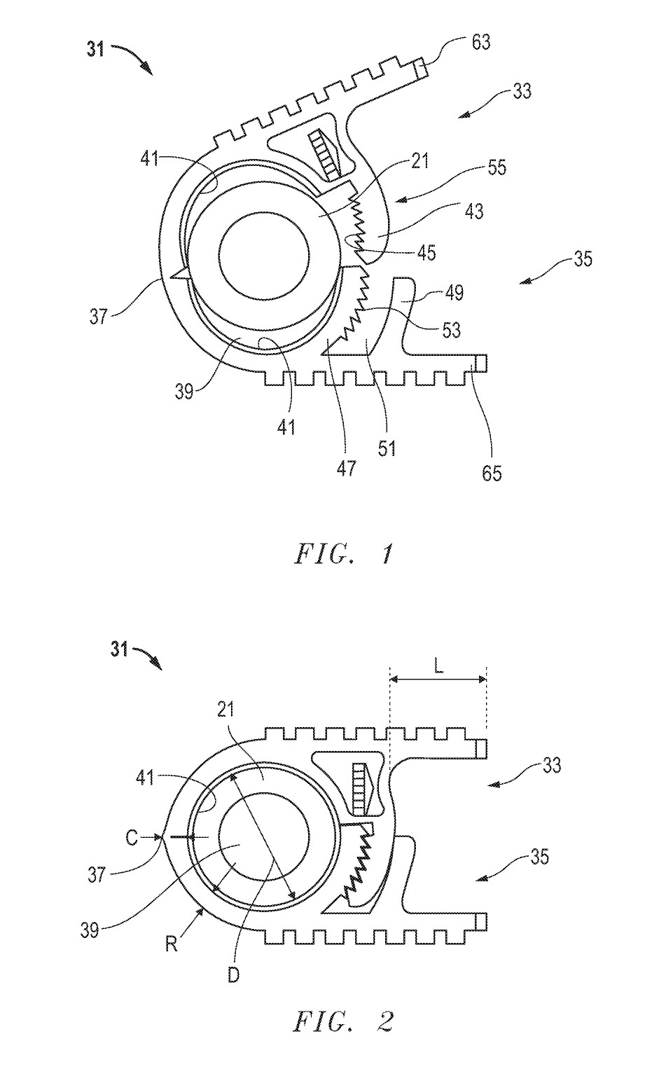

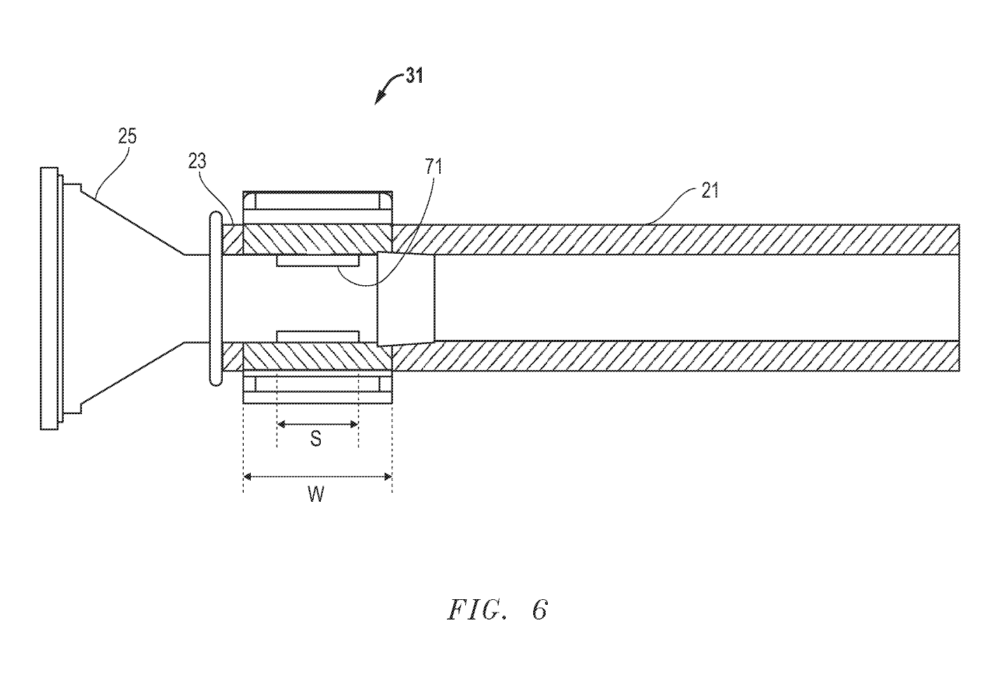

Embodiments of a system, method and apparatus for a tubing connector that creates compression between tubing and fittings are disclosed in FIGS. 1-9. For example, some embodiments (see, e.g., FIGS. 1-3) comprise a disposable plastic retainer for clenching and sealing tubing connections with barbed fittings to form an assembly or tubing system.

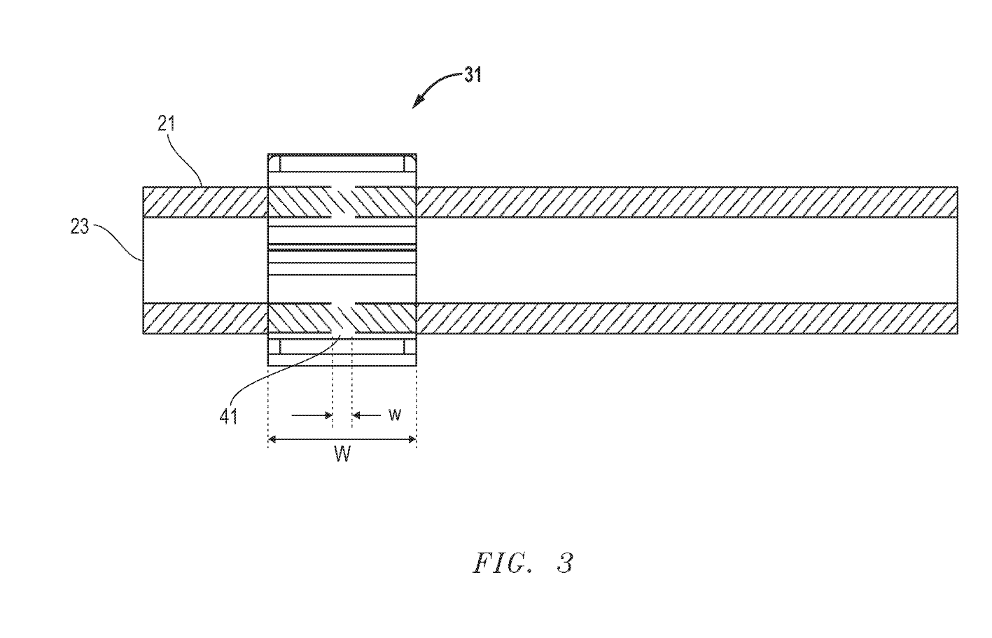

Embodiments may comprise a tubing 21 having an axial end 23 (FIG. 3). A fitting 25, such as the barbed fitting shown in FIG. 6, is inserted into the end 23 of the tubing 21. A retainer 31 is clenched (FIGS. 2 and 3) on the tubing 21 adjacent the end 23 around the fitting 25 (FIG. 6) to form a substantially 360° compression seal and connection therebetween.

In the illustrated embodiments, the retainer 31 may further comprise a body having first and second portions 33, 35 joined by one or more hinges 37 and movable from an unlocked open position (FIG. 1) to a locked closed position (FIGS. 2 and 3). The locked closed position defines an aperture 39 that is generally cylindrical with a diameter in which the tubing 21 and fitting 25 are clenched. The hinge 37 defines a slit between the first and second portions 33, 35. The retainer 31 has a radial thickness C (FIG. 2) at the hinge 37 that exceeds a radial thickness R of sidewalls of the retainer 31.

The retainer 31 may be provided with an aspect ratio of approximately 1:1, with respect to its diameter D (FIG. 2) to axial width W (FIG. 3). In other embodiments, the aspect ratio is about 0.7:1 to 1.3:1. A rib 41 is formed in and circumscribes the aperture 39. The rib 41 extends radially into the aperture 39 to reduce a diameter of at least a portion of the aperture 39. The rib 41 places a pre-load on the tubing 21 to intensify a compression force of the retainer 31. The rib 41 has an axial width w (FIG. 3) equal to approximately one-tenth of the diameter D of the aperture 39. The rib 41 is located within the aperture 39 at an axial center of the aperture 39.

In some embodiments, the first portion 33 of the retainer 31 has only a single flange 43 with a single row of teeth 45 formed on a radially inner surface thereof. The flange 43 protrudes in a circumferential direction relative to the axis of the aperture. The second portion 35 of the retainer 31 has only a pair of flanges 47, 49 that define a slot 51 therebetween for closely receiving the first portion 33. The radially inner flange 47 of the pair of flanges has a single row of teeth 53 on a radially outer surface thereof for engaging the single row of teeth 45 on the first portion 33. The radially outer flange 49 of the pair of flanges is smooth and free of teeth and closely receives (see, e.g., FIG. 2) the radially outer surface 55 of the single flange 43 opposite the single row of teeth 45 on the first portion 33.

Embodiments of each of the first and second portions 33, 35 have levers 63, 65 that extend tangentially from respective outer surfaces of the cylindrical body. The levers 63, 65 extend linearly beyond their respective flanges 33, 35 for providing leverage for a user to move the retainer 31 from the unlocked open position to the locked closed position. The levers 63, 65 extend beyond their respective flanges 33, 35 by a distance L (FIG. 2) approximately equal to half of the diameter D of the retainer 31.

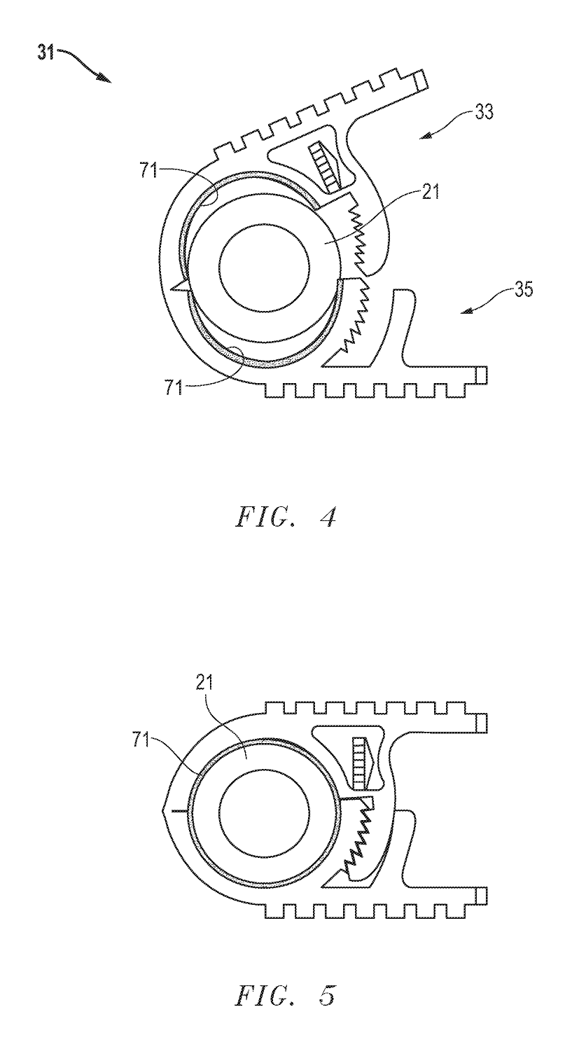

Referring to FIGS. 4-6, embodiments may further comprise a liner 71 located inside the retainer 31. The liner 71 may be formed from silicone and comprise two semi-cylindrical halves mounted to the first and second portions 33, 35 and are separated at the hinge 37. The liner 71 may be configured with an inner diameter that is equal to the outer diameter of the tubing 21. The tubing and retainer have an axis and are coaxial, and an axial width S (FIG. 6) of the liner 71 is less than an axial width W of the retainer 31.

Environmental testing was performed on both the embodiments of the invention and on conventional thermoplastic barbed connection assemblies. For example, an autoclave cycle of 123° C. for 60 minutes was conducted, followed 24 hours later by a pressure test of 40 psig for 60 minutes. The conventional solutions known in the art did not compensate for the relaxation of the connectors and tubing during the autoclave cycle. In contrast, embodiments of the invention passed the tests with no leaks.

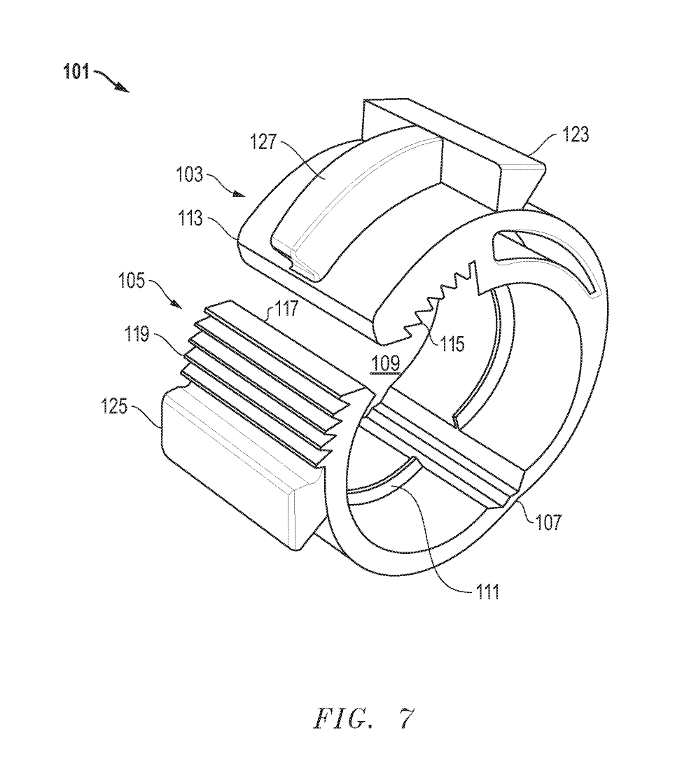

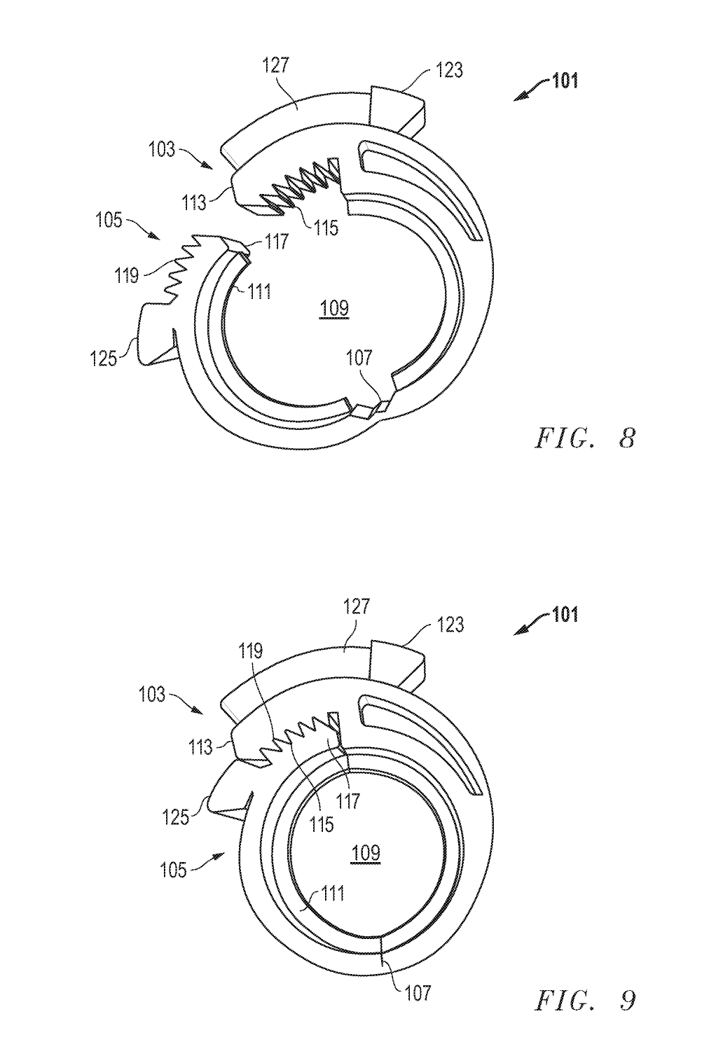

Referring now to FIGS. 7, 8 and 9, another embodiment of a retainer 101 is disclosed. Retainer 101 works in conjunction with the tubing and fittings, as described herein for other embodiments. The retainer 101 comprises a body having first and second portions 103, 105 joined by one or more hinges 107 and movable from an unlocked open position (FIGS. 7 and 8) to a locked closed position (FIG. 9). The locked closed position defines an aperture 109 that is generally cylindrical with a diameter in which the tubing and fitting are clenched. The hinge 107 defines a slit between the first and second portions 103, 105. The radial thickness of the retainer 101 may be consistent throughout its sidewalls and hinge.

As with the other retainers, retainer 101 may be provided with an aspect ratio of approximately 1:1, or about 0.7:1 to 1.3:1. A rib 111 may be formed in and substantially circumscribe the aperture 109. The rib 111 extends radially into the aperture to reduce a diameter of at least a portion of the aperture. The rib 111 places a pre-load on the tubing to intensify a compression force of the retainer 101. The rib 111 may have an axial width equal to approximately one-tenth of the diameter of the aperture 109. The rib 111 may be located within the aperture 109 at an axial center thereof.

The first portion 103 of the retainer 101 may have only a single flange 113 with a single row of teeth 115 formed on a radially inner surface thereof. The flange 113 protrudes in a circumferential direction relative to the axis of the cylindrical aperture 109. The second portion 105 of the retainer 101 also may have only a single flange 117 with radially outward facing teeth 119 for closely receiving and engaging teeth 115 of flange 113.

Embodiments of each of the first and second portions 103, 105 have ears 123, 125 that extend substantially radially from respective outer surfaces thereof. The ears 123, 125 are radially shorter than the levers of the previous embodiments. Ears 123, 125 extend beyond their respective flanges 113, 117 for providing leverage for a conventional tool (not shown) to be used by a user to move the retainer 101 from the unlocked open position to the locked closed position. Portion 103 may further comprise a gusset 127 on the outer surface of flange 113. Gusset 127 may be substantially parallel to and have the same radial dimension as ear 123. Gusset 127 also may circumscribe and be axially centered on flange 113 as shown. In other embodiments, retainer 101 may further comprise a liner as previously described herein.

The embodiments described herein have numerous advantages. The connection and seal provided by these embodiments is extremely resilient, even after being subjected to the elevated pressures and temperatures of autoclaving cycles. In some embodiments, a single piece molded plastic retainer is hand-clenched to create compression around tubing and a barbed connector. The retainer or device is ergonomically designed to be easily and permanently clenched with a single hand by a user without the use of hand tools. A gentle pinching motion with a few fingers is all that is required to secure the termination.

Embodiments of the retainer circumscribe and handcuff around the tubing with a single locking mechanism. After the device is secured in its closed position, the only way to unlock the device is to destroy the retainer or connection. The locking mechanism on the device cannot be unlocked without deforming it. Once locked, the clip can only further tighten and compress. It cannot be released or unlocked unless the clip is destroyed. Thus, embodiments of the device are designed for a single use and then disposed of.

This retainer replaces conventional zip ties and retainers that are commonly used in the pharmaceutical industry. Unlike zip ties, the connection provided by such embodiments has a very high burst pressure and no leakage at the point of the connection. The termination is so secure that the tubing will fail before the connection fails.

In other embodiments, the silicone sleeve or liner better retains and seals thermoplastic tubing. The molded, inner silicone liner may be formed using a two step injection molding method. The silicone liner may be provided with an inner diameter that matches the outer diameter of the tubing for a very precise fit.

The molded silicone liner fits over tubing connected with a barbed fitting offers superior performance. The size or inner diameter of the liner is selected based on the outer diameter of the tubing. The silicone liners are provided with the plastic clip or retainer to hold the silicone in place while under 360° of compression. The silicone liner compensates for the permanent deformation of the tubing and connector during the autoclave cycle and withstands the pressures exerted on it for the life of the part.

Conventional thermoplastics are limited to a maximum autoclave temperature of 132° C. with an exposure time of only 10 minutes. Moreover, these designs should not be clamped or placed under load during sterilization to avoid permanent deformation of the parts. In contrast, the embodiments disclosed herein may be subjected to longer and more strenuous conditions in autoclave environments while being clamped and under load without the loss of sealing and connection or damage to the retainers.

The invention is well suited for pharmaceutical and medical applications while providing connections for tubing at intersections such as Straight/Reducer Coupler, Tee, Wye or cross-junctions. The internal, central rib extends all the way around the interior surface of the retainer to put a pre-load on the tubing to intensify the compression force of the retainer over the tubing and barbed fitting. This retainer design does not uncouple, even if no tubing or other materials are clamped within the connection.

Conventional retainers are not easily installed, and are readily unclamped. In contrast, retainers in accordance with the invention are installed in more compacts space compared to existing designs, allowing shorter and closer connections to be realized. Other advantages of the invention include that it is autoclavable, sterilizable with gamma irradiation exposure, it complies with USP V1, FDA and UL standards, and is BPA free.

This written description uses examples to disclose the embodiments, including the best mode, and also to enable those of ordinary skill in the art to make and use the embodiments. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. The order in which activities are listed are not necessarily the order in which they are performed.

In the foregoing specification, the concepts have been described with reference to specific embodiments. However, one of ordinary skill in the art appreciates that various modifications and changes can be made without departing from the scope of the embodiments as set forth in the claims below. Accordingly, the specification and figures are to be regarded in an illustrative rather than a restrictive sense, and all such modifications are intended to be included within the scope of the embodiments.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of scope. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A connector for connecting tubing and a fitting, comprising:
a retainer for forming a compression seal comprising:
a body having first and second portions joined by a hinge and movable from an unlocked open position to a locked closed position, the locked closed position defining an aperture that is cylindrical with a diameter in which the tubing and fitting are clenched;
the body has an aspect ratio of about 0.7:1 to 1.3:1, with respect to the diameter and an axial width of the body; and
a rib formed in and circumscribing the generally cylindrical aperture, the rib extending radially into the aperture to reduce the diameter of at least a portion of the aperture, the rib adapted to place a pre-load on the tubing to intensify a compression force of the retainer over the tubing and fitting.

2. A connector according to claim 1, wherein the aspect ratio is approximately 1:1.

3. A connector according to claim 1, wherein the rib has an axial width equal to approximately one-tenth of the diameter of the aperture, and the rib is located within the aperture at an axial center of the aperture.

4. A connector according to claim 1, wherein the first portion has only a single flange with a single row of teeth formed on a radially inner surface thereof, and the second portion has only a pair of flanges that define a slot therebetween for closely receiving the first portion, a radially inner one of the pair of flanges having a single row of teeth on a radially outer surface thereof for engaging the single row of teeth on the first portion, and a radially outer one of the pair of flanges is free of teeth and closely receives a radially outer surface of the single flange opposite the single row of teeth on the first portion.

5. A connector according to claim 4, wherein each of the first and second portions has a lever that extends tangentially from respective outer surfaces thereof, the levers extending beyond their respective flanges for providing leverage for a user to move the retainer from the unlocked open position to the locked closed position, and the levers extend beyond their respective flanges by a distance approximately equal to half of the diameter of the retainer.

6. A connector according to claim 1, wherein the retainer is a single piece molded plastic retainer that is hand-clenched and adapted to create compression around the tubing and fitting without hand tools.

7. A connector according to claim 1, wherein the retainer is adapted to circumscribe and handcuff around the tubing with a single locking mechanism, the only way to move the retainer from the locked closed position to the unlocked open position is to destroy the single locking mechanism, the retainer can only be tightened and compressed and cannot be unlocked unless the retainer is destroyed, and cannot be unlocked even when the tubing and fitting are not located in the aperture.

8. A connector according to claim 1, further comprising a liner inside the retainer.

9. A connector according to claim 8, wherein an axial width of the liner is less than an axial width of the retainer.

10. A connector according to claim 8, wherein the liner comprises two semi-cylindrical, silicone halves mounted to the first and second portions and are separated at the hinge.

11. A connector according to claim 1, wherein the hinge defines a slit between the first and second portions, and the retainer has a radial thickness at the hinge that exceeds a radial thickness of sidewalls of the retainer.

12. A connector according to claim 1, wherein the first portion has only a single flange with a single row of teeth formed on a radially inner surface thereof, and the second portion has only a single flange with external teeth for closely receiving the single row of teeth of the first portion.

13. A connector according to claim 12, wherein each of the first and second portions has an ear that extends radially from respective outer surfaces thereof, the ears extending beyond their respective flanges for providing leverage for a tool to be used by a user to move the retainer from the unlocked open position to the locked closed position, and the first portion has a gusset on the outer surface that is perpendicular to its respective ear.

14. A tubing and connector system, comprising:
a tubing having an end;
a fitting inserted into the end of the tubing;
a retainer clenched on the tubing adjacent the end around the fitting to form a compression seal and connection therebetween, the retainer further comprising:
a body having first and second portions joined by a hinge and movable from an unlocked open position to a locked closed position, the locked closed position defining an aperture that is cylindrical with a diameter in which the tubing and fitting are clenched; and
the body has an aspect ratio of about 0.7:1 to 1.3:1, with respect to the diameter and an axial width of the body.

15. A tubing and connector system according to claim 14, wherein the aspect ratio is approximately 1:1.

16. A tubing and connector system according to claim 14, further comprising a rib formed in and circumscribing the generally cylindrical aperture, the rib extending radially into the aperture to reduce a diameter of at least a portion of the aperture, the rib placing a pre-load on the tubing to intensify a compression force of the retainer over the tubing and fitting.

17. A tubing and connector system according to claim 6, wherein the rib has an axial width equal to approximately one-tenth of the diameter of the aperture.

18. A tubing and connector system according to claim 6, wherein rib is located within the aperture at an axial center of the aperture.

19. A tubing and connector system according to claim 14, wherein the first portion has only a single flange with a single row of teeth formed on a radially inner surface thereof, and the second portion has only a pair of flanges that define a slot therebetween for closely receiving the first portion, a radially inner one of the pair of flanges having a single row of teeth on a radially outer surface thereof for engaging the single row of teeth on the first portion, and a radially outer one of the pair of flanges is free of teeth and closely receives a radially outer surface of the single flange opposite the single row of teeth on the first portion.

20. A tubing and connector system according to claim 19, wherein each of the first and second portions has a lever that extends tangentially from respective outer surfaces thereof, the levers extending beyond their respective flanges for providing leverage for a user to move the retainer from the unlocked open position to the locked closed position.

21. A tubing and connector system according to claim 20, wherein the levers extend beyond their respective flanges by a distance approximately equal to half of the diameter of the retainer.

22. A tubing and connector system according to claim 14, wherein the retainer is a single piece molded plastic retainer that is hand-clenched to create compression around the tubing and fitting without hand tools.

23. A tubing and connector system according to claim 14, wherein the retainer circumscribes and handcuffs around the tubing with a single locking mechanism, and the only way to move the retainer from the locked closed position to the unlocked open position is to destroy the single locking mechanism.

24. A tubing and connector system according to claim 23, wherein the retainer can only be tightened and compressed and cannot be unlocked unless the retainer is destroyed, and cannot be unlocked even when the tubing and fitting are not located in the aperture.

25. A tubing and connector system according to claim 14, further comprising a liner inside the retainer between the tubing and the body.

26. A tubing and connector system according to claim 25, wherein the tubing and retainer have an axis and are coaxial, and an axial width of the liner is less than an axial width of the retainer.

27. A tubing and connector system according to claim 25, wherein the liner comprises two semi-cylindrical, silicone halves mounted to the first and second portions and are separated at the hinge.

28. A tubing and connector system according to claim 25, wherein the liner has an inner diameter that is equal to an outer diameter of the tubing.

29. A tubing and connector system according to claim 14, wherein the hinge defines a slit between the first and second portions, and the retainer has a radial thickness at the hinge that exceeds a radial thickness of sidewalls of the retainer.

30. A tubing and connector system according to claim 14, wherein the first portion has only a single flange with a single row of teeth formed on a radially inner surface thereof, and the second portion has only a single flange with external teeth for closely receiving the single row of teeth of the first portion.

31. A tubing and connector system according to claim 30, wherein each of the first and second portions has an ear that extends radially from respective outer surfaces thereof, the ears extending beyond their respective flanges for providing leverage for a tool to be used by a user to move the retainer from the unlocked open position to the locked closed position, and the first portion has a gusset on the outer surface that is perpendicular to its respective ear.
